(19) United States
(12) Patent Application Publication
(10) Pub. No.: US 2026/0153731 A1
(43) Pub. Date: Jun. 4, 2026

(54) OPTICAL ELEMENT, METHOD FOR PRODUCTION THEREOF, AND ILLUMINATION DEVICE

(71) Applicant: siOPTICA GmbH, Jena (DE)

(72) Inventor: Andreas BREGULLA, Duderstadt (DE)

(21) Appl. No.: 19/121,506

(22) PCT Filed: Dec. 7, 2023
(86) PCT No.: PCT/EP2023/084741

§ 371 Date: Apr. 16, 2025

(30) Foreign Application Priority Data
Dec. 22, 2022 (DE) 10 2022 134 518.1

(51) Int. Cl. G02B 27/00; G02F 1/13357

(52) U.S. Cl. CPC G02B 27/0081; G02F 1/133606

(57) ABSTRACT

An optical element having a first light-entry surface and a second light-exit surface, and first transparent regions having a first refractive index and second partially-opaque regions with a second refractive index with at most 50% reflective or white-scattering material. The first index is higher than the second so that light impinging at the first surface is partially incident into the optical element through light-entry surfaces of the first regions or impinges on reflective or white-scattering second regions. Light is propagated or totally internally reflected inside a first region and coupled out at a light-exit surface, or refracted by the first region into an adjacent second region and absorbed, reflected or scattered by the material of the second regions, so that propagation directions of light exiting at the second surface is limited compared with light impinging on the optical element and light impinging at the second regions is reflected or scattered.

### PRIORITY CLAIM

The present application is a National Phase entry of PCT Application No. PCT/EP 2023/084741, filed Dec. 7, 2023, which claims priority from German Patent Application No. 10 2022 134 518.1, filed Dec. 22, 2022, the disclosures of which are hereby incorporated by reference herein in their entirety.

### BACKGROUND OF THE INVENTION

In recent years, great strides have been made to widen the visual angle in LCDs. However, there are often situations in which this very large viewing area of a display screen can be disadvantageous. Increasingly, information such as bank data or other personal information and sensitive data is also available on mobile devices, such as notebooks and tablets. Accordingly, people need to supervise viewing access to these sensitive data. They should be able to choose between a wide viewing angle for sharing information on their display with others, e.g., when viewing vacation photographs or for advertising purposes. On the other hand, they need a small viewing angle when they want to treat the displayed information confidentially.

A similar problem arises in the automotive industry, where the driver should not be distracted by image contents, e.g., digital entertainment programs, when the engine is running, but the passenger would like to view such images during the drive. Consequently, there is a need for a display screen that can toggle between the corresponding display modes.

Add-on films based on microlouvers have already been used for mobile displays in order to achieve protection of visual data. However, these films were not switchable (toggleable); they always had to be manually applied first and then removed again subsequently. They also had to be transported independently from the display when not in use at a particular time. A further substantial drawback in the use of such louver films is connected with the associated light losses.

U.S. Pat. No. 6,765,550 B2 describes such a protected view by means of microlouvers. The greatest disadvantage here is the mechanical removal and mechanical mounting of the filter and the light losses in protected mode.

U.S. Pat. No. 5,993,940 A describes the use of a film which has small strip-shaped prisms arranged uniformly on its surface in order to achieve a privacy mode. The development and production are quite cumbersome.

In WO 2012/033583 A1, switching between public view and restricted view is brought about by means of controlling liquid crystals between chromonic layers. There is light loss and the expenditure is quite high.

US 2012/0235891 A1 describes a very elaborate backlight in a display screen. According to FIGS. 1 and 15, not only is a plurality of light guides utilized but also additional complex optical elements such as microlens elements 40 and prism structures 50 which modulate light as it travels from the back illumination to the front illumination. This is expensive and complicated to implement and also entails light losses. According to the variant shown in FIG. 17 in US 2012/0235891 A1, both light sources 4R and 18 produce light with a narrow illumination angle. The light from the rear light source 18 is first transformed in a costly manner into light with a large illumination angle. This complex transformation sharply reduces brightness as already noted above.

According to JP 2007-155783 A, special optical surfaces 19 which are difficult to calculate and produce are used to deflect light in different narrow or wide areas depending on the incident angle of light. These structures resemble Fresnel lenses. Further, there are interference edges which deflect light in unwanted directions. Accordingly, it remains unclear whether or not meaningful light distributions can actually be achieved.

US 2013/0308185 A1 describes a special stepped light guide which radiates light onto a large area in various directions depending on the direction from which it is illuminated proceeding from a narrow side. Accordingly, in combination with a transmissive imaging display unit, e.g., an LC display, a display screen can be produced that is switchable between a public viewing mode and a limited viewing mode. One of the drawbacks here consists in that the limited-view effect can only be produced for left and right or up and down, but not for left and right and up and down simultaneously as is needed for certain payment processes, for example. In addition to this, a residual light is also always still visible in the limited-view mode from blocked viewing angles.

Applicant's WO 2015/121398 A1 describes a display screen with two modes of operation in which there are essentially scattering particles in the volume of the corresponding light guide for switching between operating modes. However, the scattering particles selected therein, which comprise a polymerizate, generally have the disadvantage that light is coupled out of both large areas so that about half of the useful light is radiated in the wrong direction, namely, toward the backlight, and cannot be recycled there to a sufficient extent because of the construction. Beyond this, the scattering particles of polymerizate which are distributed in the volume of the light guide can lead under certain circumstances, particularly at high concentrations, to scattering effects which diminish the privacy effect in the protected operating mode.

Applicant's WO 2022/078942 A1 and DE 10 2020 008 062 A1 both show an optical element which structures light passing through it with respect to its propagation directions. A disadvantage consists in that light absorbed through opaque regions is completely lost for the light balance.

Applicant's DE 10 2021 120 469 B3 describes an optical element for selectively limiting light propagation directions based on electrophoretic particles. The drawback here consists in particular in that the required switching times between operating modes are several seconds in duration.

Further, Applicant's WO 2021/032735 A1 and DE 10 2020 007 974 B3 both disclose an optical element with variable transmission. Here also, the comparatively long switching times based on the electrophoretic particle motion or electrowetting impose a limitation. Further, a light recycling cannot take place at the opaline particles.

The drawback shared by the methods and arrangements cited above is that they generally appreciably reduce the brightness of the basic display screen and/or require a complicated and expensive optical element for switching between modes and/or offer only limited protected viewing and/or reduce the resolution in the freely viewable mode and/or only permit narrow viewing areas, the brightness over the angular spectrum decreasing so rapidly that an observer sees a very inhomogeneous image with respect to brightness.

Beyond this, strenuous efforts have been undertaken to reduce reflections, e.g., on windshields, by steps for limiting emission angles. Disadvantages in the use of commercially available louver filters are, for one, the light loss and, for another, also the triangular light distribution over the angles, which often makes for an inhomogeneous image for the observer.

### SUMMARY OF THE INVENTION

Therefore, it is the object of the invention to develop a two-dimensionally extensive optical element which can influence incident light in a defined manner with respect to propagation directions thereof. The optical element is to be realizable inexpensively and, in particular, universally usable with diverse types of display screen, and the resolution of such a display screen is reduced essentially not at all or only negligibly. Further, the optical element is to afford the possibility, in principle, of achieving a top hat light distribution. By this is meant that the brightness decreases by no more than 35% in an angular range of, e.g., at least 7° around the peak emission direction or, generally, that the luminance distribution over the angles remains as close as possible to a rectangular shape. Further, a particular requirement of the optical element is to increase efficiency for the effective light transmission over that of the prior art.

The above-stated object is met according to the invention by a two-dimensionally extensive optical element having a first large surface at which light enters into the optical element and a second large surface at which light exits from the optical element, which optical element comprises, on the one hand, first regions E1 which are at least made up of a transparent material with a first refractive index N1 and, on the other hand, comprises second regions E2, at least 50% of which comprises an opaque material with a second refractive index N2 and at most 50% of which—but at least 5% or 10% of which-comprises a reflective or white-scattering material, and the first regions E1 and second regions E2 alternate over the surface of the optical element in a one-dimensional or two-dimensional sequence. The sequence is preferably periodic, but is not necessarily periodic with respect to dimensions. The first refractive index N1 is higher than the second refractive index N2 within the entire wavelength range visible to the human eye. In the second regions E2, the opaque material is arranged predominantly in direction of the second large surface of the optical element so that the reflective or white-scattering material is inherently arranged predominantly in direction of the first large surface. The first regions E1 and the second regions E2 are trapezoidally shaped, at least partially parabolically shaped and/or step shaped when viewed in section direction perpendicular to the second large surface of the optical element.

In this way, it is brought about that light impinging on the first large surface of the optical element (on the light entry side) is incident into the optical element at least partially through light entry surfaces of the first regions E1 or impinges on reflective or white-scattering second regions E2, where, depending on an incident angle of the light, the polarization of the light and/or the ratio of the first refractive index N1 to the second refractive index N2, the light is a) propagated in an unimpeded manner or is totally internally reflected inside of a first region E1 and is thereafter coupled out again at a light exit surface of the corresponding first region E1, or is b) completely or partially refracted by the first region E1 into an adjacent second region E2, where it is absorbed owing to the opaque material of the second regions E2 or is reflected or scattered owing to the reflective or white-scattering material of the second regions E2.

As a result, the light exiting from the optical element at the second large surface thereof is limited with respect to its propagation directions compared with the light impinging on the optical element at the first large surface. Further, at least a portion of the light impinging on the optical element at the first large surface at the second regions E2 is reflected or scattered. Generally, at least 25% of the impinging light is reflected or (back-)scattered.

According to the invention, the first regions E1 and second regions E2 are trapezoidally shaped, at least partially parabolically shaped and/or step shaped when viewed in section direction perpendicular to the second large surface of the optical element. The propagation directions of the light exiting from the optical element are selectively influenced by means of such constructional shapes of the first regions E1 and second regions E2. A stronger or weaker focusing of the light over the surface takes place depending on the shape. Further, it is possible, such as by means of parallelogram-shaped sectional shapes of the first regions E1 and second regions E2, to achieve a peak distribution by means of the resulting tilting of the interfaces between the first regions E1 and second regions E2. On the other hand, a trapezoidal shape has the advantage that the angular distribution is better focused thereby and the lateral protected view is further improved. Trapezoidal shapes are especially preferred as sectional shape of the first regions E1 which are wider at the second large surface (light exit side) than at the first large surface (light entry side). Substantially isosceles trapezoids are particularly preferred.

Of course, the above-described trapezoidal shape, at least partially parabolic shape and/or step shape is generally only approximately achieved in practice because of technical limitations in production and accordingly also entails relatively divergent shapes for technical reasons. Thus the at least partially parabolic shape may be desired but can also be a result of technical limitations in production if, for example, a trapezoidal shape cannot be exactly produced but, rather, is partially parabolic. However, this need not derogate from the inventive effect. Trapezoidal shapes, parabolic shapes and/or step shapes can also alternate with one another viewed in section direction perpendicular to the second large surface.

The trapezoidal shape can also be asymmetrical in order to achieve a shift of the brightness distribution relative to the normal.

Instead of a trapezoidal geometry with straight sides, the lateral surfaces of the interface between transparent and absorbent regions E1, E2 can be rounded. This has two advantages: for one, shaping is facilitated in the production of the optical element and, for another, an additional focusing effect improves the effective transmission and limiting of the propagation directions.

The opaque material need not necessarily have an opacity of 100%, but the highest possible opacity should be sought. The opacity required for a respective application can be determined by means of ray tracing simulations based on the desired brightness distribution referring to the transmission curve.

Because of the different first refractive index N1 and second refractive index N2, rays penetrating into second regions E2 are refracted more strongly away from the perpendicular before being absorbed in the second region E2. This generally reinforces the absorption effect.

Further, the aforementioned difference in refractive index from N1 to N2 between the first regions E1 and second regions E2 generates a different angular spectrum when light passes through the optical element than would be the case if this difference in refractive index did not exist, since a portion of the light is reflected back again into regions E1 by total internal reflection and is then further available for the light balance. Therefore, the optical element is fundamentally capable of achieving a top hat light distribution. As was described in the introduction, this means that the luminance distribution over the angles, e.g., in horizontal direction as viewed by a standing or sitting observer, remains as close as possible to a rectangular shape. Depending on the configuration, it is thus possible that the brightness decreases by no more than 35%, or even than 25%, in an angular range of at least 7°around the peak emission direction. Further, a good efficiency can be achieved because of the proportion of reflecting or white-scattering material.

Further, a substrate S and/or a cover layer D between which or on which the regions E1 and E2 are arranged can be provided at the optical element.

That portion of light impinging on the optical element at the first large surface thereof that is reflected or scattered—particularly at the second regions E2—should typically be at least 20% to 25% or more and can be recycled, e.g., in a light source located below it. The efficiency of the recycled light is also increased by as much as a factor of three by the focusing effect of the above-described structures of the optical element.

Accordingly, the material located at the large surface of the optical element in the second regions E2 which has a reflective or white-scattering effect sends at least a portion of the light incident thereupon back to its point of origin. In this regard, the at least partial reflection may be specular or diffuse.

In the second regions E2, the ratio of opaque material to reflective or white-scattering material can be, for example, a) 50/50, b) 50/40, c) 70/30, e) 80/20, f) 75/25 (preferred), or g) 90/10. Other configurations are possible and lie within the scope of the invention.

In order to facilitate production, the above-mentioned reflective or white-scattering material can comprise a transparent material with the second refractive index N2 or a transparent material that is suitable for the filling process, has a refractive index that is less than or greater than N2 and is mixed with reflective and/or white-scattering particles, as a result of which a reflective or white-scattering effect is brought about as a whole. Accordingly, this material found in the second regions E2 could be realized, for example, as a mixture of nanoparticles or microparticles which are distributed in a transparent coating.

TiO₂ particles or SiO₂ particles, powder/varnish mixtures or the like filling material, for example, are contemplated as particles. Silver, aluminum or chromium can also be vapor-deposited or applied via a solvent which is then evaporated, letting a reflective metal layer form. Further, the scattering or reflective effect can also be produced by selective evaporation or sputtering of the boundary areas between the first regions E1 and second regions E2, e.g., by means of aluminum, chromium or other metallic or dielectric layers. It is further possible, as with a varnish, to introduce the corresponding material in solution in the second regions E2, but with the solvent being subsequently evaporated, e.g., by heating, and the desired material correspondingly left behind in the structures.

The opaque material can comprise, for example, a transparent material with the second refractive index N2 which is mixed with absorbent particles, as a result of which an opaque effect is brought about as a whole.

Accordingly, it is contemplated that the opaque material comprises a varnish or polymer which is mixed with graphite particles having a size of less than 500 nm, with nanoparticles of carbon black having a size of less than 200 nm, with iron(II, III)oxide particles, with MnFe₂O₄ particles, with dyes or with dye mixtures as absorbent particles.

The mass percentage of absorbent particles should be at most 75%. With respect to graphite particles, the mass percentage should only be between 5% and 30%, inclusive. In case of iron(II, III)oxide particles, a mass percentage of 10% to 75%, inclusive, is preferred.

The difference in refractive index between the first refractive index N1 and the second refractive index N2 should be less than 0.15 but, at most, 0.2.

Further, the first regions E1 and second regions E2 are preferably arranged so as to be distributed in alternating stripes over the surface of the optical element viewed in parallel projection perpendicular to the optical element. By “periodic sequence” of the first regions E1 and second regions E2 is not meant that these regions must always be equally wide and/or high, but rather that the first regions and second regions merely always alternate. However, their size can vary. Accordingly, the limiting of the light propagation directions would be operative perpendicular to the stripe-shaped regions but not parallel to them.

In contrast, another embodiment provides that the first regions E1 are arranged so as to be distributed over the surface of the optical element in a point-shaped, circular, oval-shaped, rectangular, hexagonal or otherwise two-dimensionally shaped manner when viewed in parallel projection perpendicular to the optical element, and the second regions E2 are shaped in a complementary manner. In this way, the limiting of the light propagation directions would be effective in each instance in at least two planes extending perpendicular to the surface of the optical element. In practice, the effect of such an optical element is generally such that the light propagation directions for transmitted light are focused in every angle close to the perpendicular bisectors of the optical element or parallel thereto. By “close” is meant in this instance that the deviations from the perpendicular bisectors or parallels thereto are less than 25° or 30° depending on the configuration.

Other shapes of the first regions E1 and second regions E2 are also possible. It is always important for maintaining the functioning of the invention that the first regions E1 and second regions E2 directly adjoin one another optically so that an optical jump in the refractive index happens without an air gap as far as possible.

Beyond this, it is possible to apply a lens structure L, preferably a convex lens structure, to at least some of the first regions E1, preferably to all of the first regions E1 at the light exit side thereof. A further focusing of the light penetrating the optical element is achieved in this way.

For particular cases of application, it is possible that there is formed on the optical element at least a first region E1 whose shortest dimension when viewed in parallel projection perpendicular to the optical element is at least twenty times larger than the shortest dimension of all of the second regions E2 viewed in parallel projection perpendicular to the optical element so that, inside of the above-mentioned at least one first region E1—excluding at the edges thereof and with the exception of losses and parallel shifts—there is no limiting of the propagation directions of the light exiting from the optical element at the light exit side versus the light impinging on the optical element on the light entry side.

Beyond this, further regions E3 and E4, . . . can be formed in addition to the first regions E1 and second regions E2, which further regions E3 and E4, . . . have different parameters with respect to shape and/or refractive index than those of the first regions E1 and second regions E2, so that light which penetrates these further regions E3, E4, . . . and exits from the optical element undergoes limitations of the propagation directions that differ from those in the first regions E1. The invention also comprises a method for the production of an above-described optical element which comprises first regions E1 and second regions E2 which alternate over the surface of the optical element 10 in a one-dimensional or two-dimensional sequence. The method includes the following steps:
forming the first regions E1 with a transparent material with a first refractive index N1 on a substrate S, e.g., in a nanoimprint process such as, for example, roll-to-to roll UV nanoimprint, by which intermediate spaces occur in each instance between every two first regions E1,
partially—but not completely—filling the intermediate spaces with an opaque material with a second refractive index N2 so that these intermediate spaces are filled to at least 50% of their height, as a result of which the second regions E2 are partially formed; this can be implemented in one or more filling steps;
further filling the intermediate spaces with a diffusely or specularly reflective material, as a result of which the second regions E2 are also completed, but the regions E2 are formed of the diffusely or specularly reflective material by at most 50% of their height; the material used for this purpose need not be 100% opaque; an opacity of at least 25% is often sufficient.

As a final step, the method optionally also comprises a sealing of the first regions E1 and second regions E2 on the side thereof not facing the substrate by applying a varnish or a cover layer.

It is also possible in principle to use another material in place of a diffusely or specularly reflective material. However, the interfaces between regions E1 and E2 are then coated with one or more diffusely or specularly reflective materials.

Alternatively, for sealing, a film (as cover layer) with an OCA (optically clear adhesive) which protects the structure from mechanical stresses and environmental conditions may be laminated on.

Further, it is possible for a DBEF™ film (Dual Brightness Enhancement Film, e.g., by 3M™) to be laminated on. This film functions as a protective layer and simultaneously increases the effective transmission owing to polarization recycling. The light focusing is further improved when the transmitted polarization is perpendicular to the main propagation directions of regions E1 because the optical functioning of the structures is polarization-sensitive.

The incident angle of the light or, synonymously, of a light ray, in the first regions E1 refers to the geometrical incident direction, in particular to a direction vector of the light describing the horizontal and vertical incident angle on the light entry surface-also referred to as “bottom surface”—of a first region E1 and, along with the polarization state of the light, is of the utmost importance for the further propagation of the light in every such first region E1 or at the interfaces with second regions E2.

It should be noted here for a clear understanding in terms of physics that “refractive index” means either the first refractive index N1 or second refractive index N2 for a selected wavelength, e.g., 580 nm, or the respective dispersion curve over the entire wavelength range visible to the human eye. In the case of the dispersion curve, the difference in the refractive index designates the respective value that corresponds to the difference between the two refractive indices at a (in principle, freely) selected wavelength 2 in the visible wavelength range.

In case a substrate and/or a cover layer is present, the latter can optionally comprise the same material as the first regions E1.

Further, it can be helpful to arrange a polarizer, optionally a reflective polarizer, below and/or above the optical element to optimize the effect. Control of the polarization by means of a polarizer allows the refractive index transitions to be utilized more efficiently. Further, a p-polarization of the incident or emergent light can be utilized to minimize Fresnel reflections, i.e., to optimize the limiting of the light propagation directions.

It generally applies for all of the optical elements that the roughness Ra at the interfaces between the first regions E1 and second regions E2 with different refractive indices N1, N2 should be less than or equal to 400 nm, preferably less than 100 nm, particularly preferably less than 40 nm.

The invention becomes particularly significant when an above-described optical element is used with an imaging display unit, e.g., an LCD panel, an OLED or micro-LED or imaging display units with a pixel structure which are based on other display technologies, or with an illumination device for a transmissive imaging display unit, e.g., an LCD panel. In the latter case, the optical element would be directly integrated in the illumination device for a transmissive imaging display unit, such as an LCD panel. This illumination device can then permanently act as a directed backlight and can accordingly be used, for example, in configurations according to Applicant's WO 2015/121398 A1 or WO 2019/002496 A1.

In case an optical element according to the invention is arranged in front of an imaging display unit in viewing direction, optics which substantially concentrate the light emitted by the respective pixels of the imaging display unit onto the surfaces opposite the first regions E1 can optionally be provided on the imaging display unit. This is possible, for example, with microlens arrays or lenticular elements which have roughly the periods of the pixel widths (or possibly the pixel heights). In the best case, the periods of the first regions E1 should then correspond to the periods of the pixel widths or pixel heights. A particularly high transmission efficiency of the optical element is achieved in this way.

The various embodiments of the invention described above can also be realized directly on a self-emissive imaging display unit. In this respect, OLED panels, described in more detail in the following, are particularly suitable. However, other self-emissive display types are also contemplated.

The implementation can be carried out, for example, in the following manner: the first regions E1 comprising a material with the first refractive index N1 are applied directly to the luminous region of an OLED pixel. The second regions E2 with structures complementing the first regions E1 are applied to the non-luminous regions of the OLED panel.

For particular configurations, the invention can also be expanded in such a way that a transparent material with refractive index N3 is inserted between all of the regions with materials with refractive indices N1 and N2, where N1>N3>N2.

In principle, the performance capability of the invention is unaffected by varying, within limits, the above-described parameters.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following with reference to drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to prevent repetition. The drawings show:

FIG. 1 a schematic sectional view of a prior-art optical element;

FIG. 2 a schematic sectional view of an optical element in a first embodiment;

FIG. 3 a schematic sectional view of an optical element in a second embodiment;

FIG. 3a a schematic sectional view of an optical element based on the second embodiment from FIG. 3; and

FIG. 4 a schematic sectional view of an LCD display screen which comprises an optical element in a first embodiment in addition to a backlight.

### DETAILED DESCRIPTION OF THE DRAWINGS

The drawings are not to scale and are merely schematic depictions. Moreover, for the sake of clarity, generally only a few light rays are depicted, although there are many such light rays in reality.

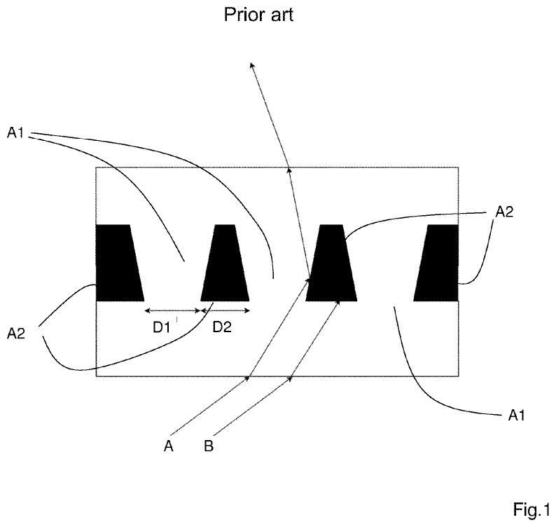

FIG. 1 shows a sectional view of an optical element from the prior art. It will be noted that while an incident (from below) light ray A can penetrate the optical element with a desired deflection through a region A1, the incident light ray B is absorbed by a region A2. Since light rays B are absorbed to a larger extent—depending on the ratio of the bottom surfaces of regions A1 and A2—when the light impinges on the optical element-more precisely, on regions A2—the light efficiency in optical elements of this type is severely limited in the prior art.

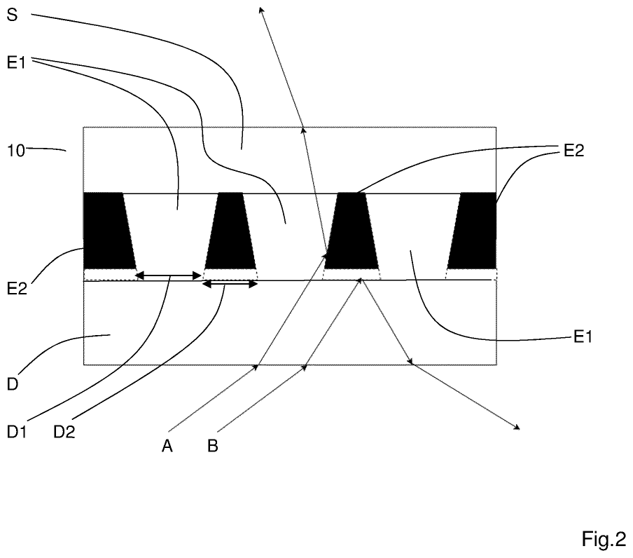

In contrast, FIG. 2 shows a schematic sectional view of an optical element in a first embodiment of the invention. This two-dimensionally extensive optical element 10 with a first large surface—also referred to as light entry side—at which light enters the optical element 10 and with a second large surface—also referred to as light exit side—at which light exits the optical element 10 comprises first regions E1 which are at least made up of a transparent material with a first refractive index N1 and second regions E2, at least 50% of which comprises an opaque material with a second refractive index N2 and at most 50% of which comprises a reflective or white-scattering material. In the example shown in FIG. 2, approximately 80% opaque material and approximately 20% white-scattering material are used. The first regions E1 and the second regions E2 alternate over the surface of the optical element 10 in a one-dimensional or two-dimensional sequence-preferably a periodic sequence, although not necessarily with respect to dimensions. The first refractive index N1 is higher than the second refractive index N2 within the entire wavelength range visible to the human eye and, in the second regions E2, the opaque material is arranged predominantly in direction of the second large surface of the optical element 10 so that the reflective or white-scattering material is inherently arranged predominantly in direction of the first large surface. The first regions E1 and the second regions E2 are trapezoidally shaped, at least partially parabolically shaped and/or step shaped when viewed in section direction perpendicular to the second large surface of the optical element 10.

In this way, it is brought about that light impinging at the first large surface of the optical element 10 (on the light entry surface) is incident into the optical element 10 at least partially through light entry surfaces of the first regions E1 or impinges on reflective or white-scattering second regions E2, where, depending on an incident angle of the light, the polarization of the light and/or the ratio of the first refractive index N1 to the second refractive index N2, the light is a) propagated in an unimpeded manner or totally internally reflected inside of a first region E1 and is thereafter coupled out again at a light exit surface of the corresponding first region E1 (example of light ray A), or is b) completely or partially refracted by the first region E1 into an adjacent second region E2, where it is absorbed owing to the opaque material of the second regions E2 or is reflected or scattered owing to the reflective or white-scattering material of the second regions E2.

As a result, the light exiting from the optical element 10 at the second large surface thereof is limited with respect to its propagation directions compared with the light impinging on the optical element 10 at the first large surface. Further, at least a portion of the light impinging on the optical element 10 at the first large surface thereof is reflected or scattered (exemplary light ray B in FIG. 2). Generally, at least 25% of the impinging light is reflected or (back-)scattered depending on the configuration.

Preferably, a cover layer D and a substrate S are provided, both of which have refractive index N1, or their refractive index deviates only slightly therefrom in each case, i.e., by a difference of less than 0.02.

Exemplary dimensions and parameters of the optical element are listed as follows: The first regions E1 have at their light entry surfaces in direction of the first large surface a width D1 which is generally smaller than a width D2 of the second regions at the light entry surfaces thereof. For example, width D1 can amount to between 10 μm and 70 μm, preferably 25 μm, and width D2 can amount to approximately 5 μm to 20 μm or more—for example, 30 μm at a width D1 of 25 μm. The total height of the first regions E1 and second regions E2 can then amount to between 50 μm and 250 μm, preferably 125 μm. The interfaces between the first regions E1 and second regions E2 form an angle differing from 0°, for example, an angle between 3° and 12°, preferably, for example, 5.5°, with the perpendicular on the light entry surfaces-lying parallel to one another-of the regions. The regions E1 are wider in direction of their light exit surfaces or towards the second interface of the optical element. In this configuration, the first refractive index N1 can be a value, for example, between 1.44 and 1.7, and the second refractive index N2 can then be a value between 1.35 and 1.6, where N2 is always less than N1. For example, N1 can equal 1.56 and N2 can equal 1.45.

External factors, such as pixel width, pixel shape and pixel height, type of display with which the optical element 10 is to be used, requirements for limiting the propagation directions, and possibly further parameters, can influence the choice of the above-mentioned dimensions.

Because of the different first refractive index N1 and second refractive index N2, rays penetrating into second regions E2 are refracted more strongly away from the perpendicular before being absorbed in the second region E2. This generally reinforces the absorption effect.

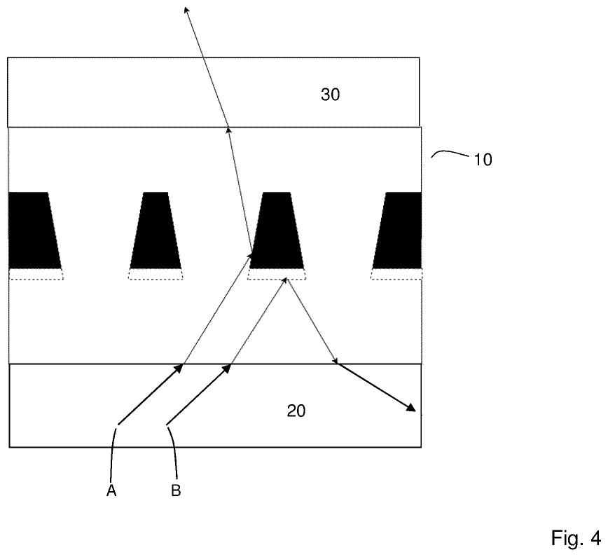

That portion of light impinging on the optical element 10 at the first large surface thereof that is reflected or scattered-particularly at the second regions E2—should typically be at least 20% to 25% or more and can be recycled, e.g., in a light source—not shown in FIG. 2—located below it, for example, in the backlight 20 shown in FIG. 4. The efficiency of the recycled light is also increased by as much as a factor of three by the focusing effect of the above-described structures of the optical element.

Accordingly, the material at the large surface of the optical element 10 in the second regions B2 which has a reflective or white-scattering effect sends at least a portion of the light incident thereupon back to its point of origin. In this regard, the at least partial reflection may be specular or diffuse.

This reflective or white-scattering material can comprise, for example, a transparent material, such as varnish or another polymer material with the second refractive index N2 which is mixed with reflective and/or white-scattering particles, as a result of which a reflective or white-scattering effect is brought about as a whole. Accordingly, this material found in the second regions E2 could be realized, for example, as a mixture of nanoparticles or microparticles which are distributed in a transparent varnish. Other configurations are contemplated.

TiO₂ particles or SiO₂ particles, powder/varnish mixtures or the like filling material, for example, are contemplated as particles. Silver, aluminum or chromium can also be vapor-deposited or applied via a solvent which is then evaporated and brings about a reflective metal layer. Further, the scattering or reflective effect can also be produced by selective evaporation or sputtering, e.g., by means of aluminum, chromium or other metallic or dielectric layers. It is further possible, as with a varnish, to introduce the corresponding material in solution in the second regions E2, but with the solvent being subsequently evaporated, e.g., by heating, and the desired material correspondingly left behind in the structures.

The opaque material can comprise, for example, a transparent material, such as PMMA or polycarbonate or, generally, a polymer, with the second refractive index (N2) which is mixed with absorbent particles, as a result of which an opaque effect is brought about as a whole.

Accordingly, it is contemplated that the opaque material comprises a varnish or polymer which is mixed with graphite particles having a size of less than 500 nm, with nanoparticles of carbon black having a size of less than 200 nm, with iron(II, III)oxide particles, with MnFe₂O₄ particles, with dyes or with dye mixtures as absorbent particles.

The mass percentage of absorbent particles should be at most 75%. With respect to graphite particles, the mass percentage should only be between 5% and 30%, inclusive. In case of iron(II, III)oxide particles, a mass percentage of 10% to 75%, inclusive, is preferred.

Further, the first regions E1 and second regions E2 are advisably arranged to be distributed in alternating stripes over the surface of the optical element 10 viewed in parallel projection perpendicular to the optical element 10, and a plurality of first regions E1 and second regions E2 are advisably provided. By “periodic sequence” of the first regions E1 and second regions E2 is not meant that these regions must always be equally wide and/or high, but rather that the first regions and second regions merely always alternate. However, their size can vary. Accordingly, the limiting of the light propagation directions would be operative perpendicular to the stripe-shaped regions but not parallel to them.

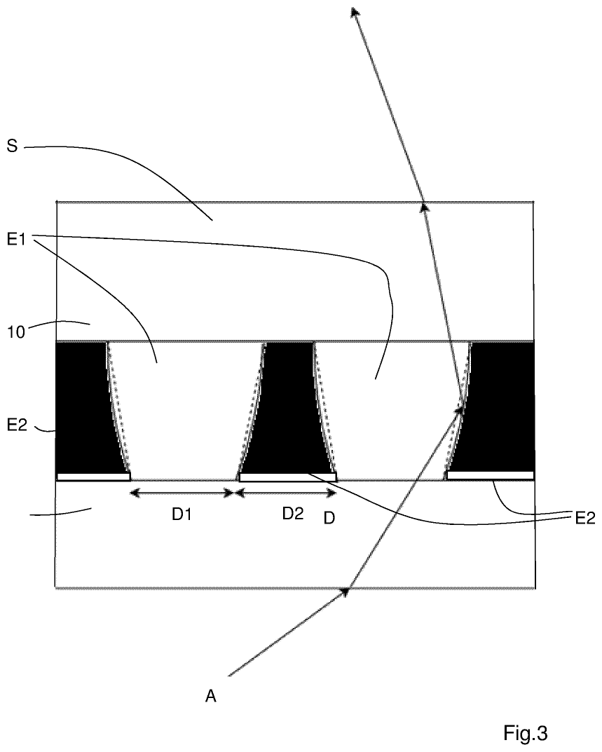

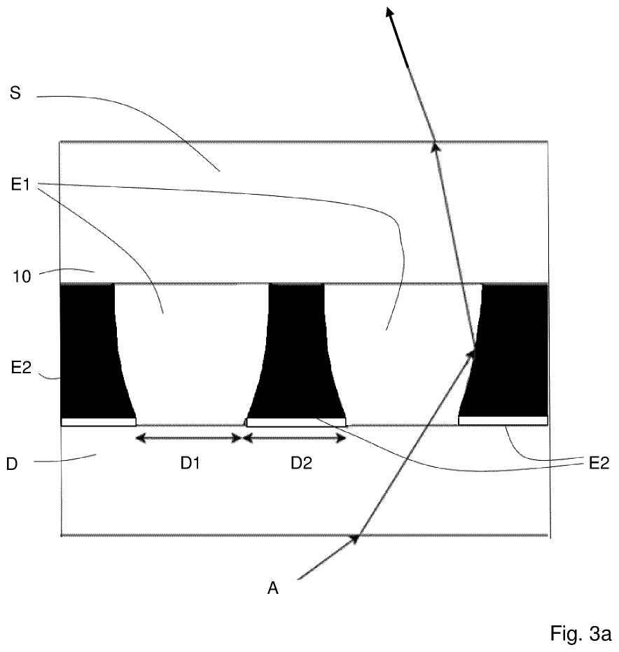

Further embodiments provide that the first regions E1 and/or second regions E2 are trapezoidally shaped or at least partially parabolically shaped viewed in section direction perpendicular to the upper surface of the optical element 10. While FIG. 2 shows an exemplary trapezoidal shape, an exemplary parabolic shape is shown in FIG. 3 in a schematic sectional view of an optical element 10 in a second embodiment, where the dotted lines show the deviation of the parabolic shape relative to a trapezoidal shape. FIG. 3a, also in a sectional schematic view of an optical element 10, shows even better the at least partially parabolic shape of the first regions E1 and/or second regions E2 viewed in section direction perpendicular to the upper surface of the optical element 10.

The propagation directions of the light exiting from the optical element are selectively influenced by means of such constructional shapes of the first regions E1 and second regions E2. A stronger or weaker focusing of the light over the surface takes place depending on the shape. In this regard, the term “focusing” does not mean an optical focusing with lenses on a focal point but rather a stronger or weaker fanning out of a bundle of light rays which exits the second large surface.

When the lateral surfaces of the interface between the first regions E1 and the second regions E2, as described above, are rounded, for example, like the parabolic shape shown in FIGS. 1 and 3a, this offers two advantages: for one, shaping is facilitated in the production of the optical element 10 and, for another, an additional focusing effect improves the effective transmission and limiting of the propagation directions. Ray B, not shown in FIGS. 3 and 3a, is also reflected analogous to the depiction in FIG. 2 and FIG. 4.

Taken as a whole, it is to be noted that because of the existing means-effect relationships owing to a trapezoidal or parabolic shape a desired focusing can be achieved which, e.g., in combination with a reflective coating at the light entry surface of the optical element 10, can achieve an effective transmission of over 100%, i.e., the light exiting from the first regions E1 has a higher luminance than light incident into the first regions E1.

Further, the invention is also compatible for use with films known from the art, such as DBEF™ film (Dual Brightness Enhancement Film, e.g., by 3M™), wire grid polarizers, and also, to a large extent, with BEFs (prismatic films). The use of such films additionally increases the effective transmission. In theory, the previously indicated exemplary dimensions and parameters achieve a gain in luminance by factor of two, for example, namely, in addition to gains that can be obtained by means of DBEF or BEF, and a top hat distribution in the range of +/−20° (horizontally from an observer's perspective) is possible.

A method for the production of the above-described optical element 10 which comprises first regions E1 and second regions E2 which alternate over the surface of the optical element 10 in a one-dimensional or two-dimensional sequence includes the following steps:
forming the first regions E1 with a transparent material with a first refractive index N1 on a transparent substrate S-with regard to the substrate S, see also FIG. 2; substrate S can comprise, for example, glass or a polymer,
by which intermediate spaces occur in each instance between every two first regions E1,
partially—but not completely—filling the intermediate spaces with an opaque material with a second refractive index N2 so that these intermediate spaces are filled to at least 50% of their height, as a result of which the second regions E2 are partially formed, and this can be implemented in one or more filling steps,
further filling the intermediate spaces with a diffusely or specularly reflective material, as a result of which the second regions E2 are completed, but the second regions E2 are formed of the diffusely or specularly reflective material by at most 50% of their height.

A final, optional step comprises the sealing of the first regions E1 and second regions E2 on the side thereof not facing the substrate by applying a varnish or a cover layer D—regarding cover layer D, see also FIG. 2. Like substrate S, the cover layer D also preferably—but not necessarily—has refractive index N1.

The incident angle of a light ray into the first regions E1 refers to the geometrical incident direction, in particular to a direction vector of the light describing the horizontal and vertical incident angle on the light entry surface—also referred to as “bottom surface”—of a first region E1 and, along with the polarization state of the light, is of the utmost importance for the further propagation of the light in the first region E1 or at the interfaces with second regions E2.

For example, the refractive indices can be N1=1.6 and N2=1.5 at a wavelength of, e.g., 550 nm. It should be noted here for a clear understanding in terms of physics that “refractive index” means either the first refractive index N1 or second refractive index N2 for a selected wavelength, e.g., 580 nm, or the respective dispersion curve over the entire wavelength range visible to the human eye. In the case of the dispersion curve, the difference in the refractive index designates the respective value that corresponds to the difference between the two refractive indices at a selected visible wavelength λ.

It generally applies for all of the optical elements 10 that the roughness Ra at the interfaces between the first regions E1 and second regions E2 with different refractive indices N1, N2 should be less than or equal to 400 nm, preferably less than 100 nm, particularly preferably less than 40 nm.

The invention becomes particularly significant when an above-described optical element 10 is used with an imaging display unit, e.g., an LCD panel, an OLED or micro-LED or imaging display units with a pixel structure which are based on other display technologies, or with an illumination device for a transmissive imaging display unit, e.g., an LCD panel. In the latter case, the optical element 10 would be directly integrated in the illumination device for a transmissive imaging display unit 30, such as an LCD panel.

FIG. 4 shows a schematic sectional view of an LCD display screen which, in addition to a backlight 20, also comprises an optical element 10 in a first embodiment and an LCD panel 30. This construction functions in principle for all types of backlights 20, but particularly for edge illumination (edge-lit) and direct illumination (local dimming or matrix LED). Besides LCD panels 30, other types of backlit imaging display units can also be used. Exemplary light rays A and B are shown in the drawing, although in reality there is a large number of different light rays. As previously described, light ray A penetrates the optical element 10 and, after that, LCD panel 30. In contrast, light ray B is reflected back into the backlight 20, where it is—at least for the most part—recycled, i.e., after penetrating different layers, the corresponding light is thrown back once more to the optical element 10, which explains the increased efficiency compared to the prior art.

In this variant, a DBEF film can also be laminated onto the back side of the LCD panel 30 in order to further increase efficiency. A DBEF film allows polarization recycling, i.e., polarized light not suitable for the input-side polarizer is—at least for the predominant part—reflected by the DBEF film and can be recycled for the most part.

Further, an illumination device with an optical element can permanently act as directed backlight and can accordingly be used, for example, in configurations according to Applicant's WO 2015/121398 A1 or WO 2019/002496 A1 in order to achieve an arrangement which is switchable between at least two different luminance distributions, such as for illumination of an LCD panel which can then be operated in a free viewing mode and in a protected viewing mode.

The various embodiments of the invention described above can also be realized directly on a self-emissive imaging display unit. In this respect, OLED panels, described in more detail in the following, are particularly suitable. However, other self-emissive display types are also contemplated.

The implementation can be carried out, for example, in the following manner: the first regions E1 comprising a material with the first refractive index N1 are directly applied to, or are arranged on, the luminous region of an OLED pixel. The second regions E2 with structures complementing the first regions E1 are applied to, or arranged on, the non-luminous regions of the OLED panel.

The invention meets the above-stated object. A two-dimensionally extensive optical element has been described which can influence incident light in a defined manner with respect to propagation directions thereof. The optical element is realizable inexpensively and, in particular, is universally usable with diverse types of display screen, and the resolution of such a display screen is reduced essentially not at all or only negligibly. Further, the optical element can achieve a top hat light distribution. Moreover, the optical element increases the efficiency for the effective light transmission compared with the prior art, as is desired. When used in a display screen, depending on the configuration, the optical element can efficiently limit the fanning out of light rays compared with a display screen without such an element and can bundle or focus the light propagation directions more sharply, which leads to a privacy effect.

The advantages of the invention are multifaceted. The modes of operation mentioned above are produced with an individual optical element which need not comprise special surface structures. Beyond this, the preferred top hat distribution is achieved with incident light and a privacy contrast of any magnitude can be achieved in experimental simulations. When an optical element according to the invention is applied in a backlight for an LCD panel, a high irradiance and good light recycling are achieved. Moreover, the limiting of light propagation in two planes, e.g., left and right and top and bottom simultaneously, is possible with only one optical element.

The invention described above can advantageously be used in combination with an imaging display unit anywhere that confidential data are displayed and/or entered, such as when entering a PIN number or displaying data in automatic teller machines or payment terminals or for entering passwords or when reading emails on mobile devices. The invention can also be applied in passenger cars, such as when the driver should not see particular image contents that are viewed by the passenger, such as entertainment programs. Further, the optical element according to the invention can be used for other technical and commercial purposes, such as for light orientation of dark-field illumination for microscopes and, broadly, for light shaping for lighting, such as for headlights and in measuring technology.

### REFERENCE CHARACTERS

10 optical element
20 backlight
30 LCD panel
A light ray
A1 region
A2 region
B light ray
D cover layer
D1 width of a first region
D2 width of a second region
E1 first region
E2 second region
S substrate

1. A two-dimensionally extensive optical element, comprising:
a first large surface at which light enters into the optical element, a second large surface at which light exits from the optical element,
first regions which are at least made up of a transparent material with a first refractive index, and
second regions, at least 50% of which comprises an opaque material with a second refractive index and at most 50% of which comprises a reflective or white-scattering material, wherein the first regions and second regions alternate over the surface of the optical element in a one-dimensional or two-dimensional sequence, wherein the first refractive index is higher than the second refractive index within the entire wavelength range visible to the human eye, and wherein, in the second regions, the opaque material is arranged predominantly in direction of the second large surface of the optical element,
wherein the first regions and the second regions are parabolically shaped, at least partially parabolically shaped or step shaped when viewed in a section direction perpendicular to the second large surface of the optical element,
so that light impinging at the first large surface of the optical element is incident into the optical element at least partially through light entry surfaces of the first regions or impinges on either reflective or white-scattering second regions, where, depending on an incident angle of the light, polarization of the light and/or a ratio of the first refractive index to the second refractive index, the light is:
propagated in an unimpeded manner or totally internally reflected inside of a first region and is thereafter coupled out again at a light exit surface of the corresponding first region, or
completely or partially refracted by the first region into an adjacent second region, where it is absorbed owing to the opaque material of the second regions or is reflected or scattered owing to the reflective or white-scattering material of the second regions,
the light exiting from the optical element at the second large surface thereof is limited with respect to its propagation directions compared with the light impinging on the optical element at the first large surface, and
wherein, further, the light impinging on the optical element at the first large surface at the second regions is at least partially reflected or scattered.

2. The optical element according to claim 1, wherein the opaque material comprises a transparent material with the second refractive index which is mixed with absorbent particles, as a result of which an opaque effect is brought about as a whole.

3. The optical element according to claim 1, wherein the opaque material comprises a varnish or polymer which is mixed with graphite particles having a size of less than 500 nm, with nanoparticles of carbon black having a size of less than 200 nm, with iron(II, III)oxide particles, with MnFe₂O₄ particles, and with dyes or with dye mixtures as absorbent particles.

4. The optical element according to claim 1, wherein the reflective or white-scattering material comprises a transparent material which is mixed with reflective and/or white-scattering particles so that a reflective or white-scattering effect is brought about as a whole.

5. The optical element according to claim 1, wherein a difference in refractive index between the first refractive index and the second refractive index is less than 0.2.

6. The optical element according to claim 1, wherein the first regions and the second regions are arranged to be distributed in alternating stripes over the surface of the optical element viewed in parallel projection perpendicular to the optical element.

7. The optical element according to claim 1, wherein the first regions are arranged so as to be distributed over the surface of the optical element in a point-shaped, circular, oval-shaped, rectangular or hexagonal manner when viewed in parallel projection perpendicular to the optical element, and the second regions are shaped in a complementary manner.

8. A method for the production of an optical element according to claim 1, which comprises first regions and second regions, wherein the first regions and the second regions alternate over the surface of the optical element in a one-dimensional or two-dimensional sequence, comprising the following steps:
forming the first regions with a transparent material with a first refractive index on a substrate S, wherein intermediate spaces occur in each instance between every two first regions,
partially filling the intermediate spaces with an opaque material with a second refractive index so that these intermediate spaces are filled to at least 50% of their height, as a result of which the second regions are partially formed,
further filling the intermediate spaces with a diffusely or specularly reflective material, as a result of which the second regions are completed.

9. the method according to claim 8, further comprising as a final step a sealing of the first regions and second regions on a side thereof not facing the substrate by applying a varnish or a cover layer.

10. An illumination device for a transmissive display screen, comprising
a backlight, and
an optical element according to claim 1,
wherein, owing to an optical effect of the optical element, the illumination device transmits light which is limited with respect to its propagation directions.
